(19) United States
(12) Patent Application Publication
(10) Pub. No.: US 2002/0051735 A1
(43) Pub. Date: May 2, 2002

(54) Apparatus for treating objects

(75) Inventors: Claudia Dorenkamp, Muehlhausen (DE); Stefan Kuenkel, Karlsruhe (DE); Andreas Kapplein, St. Leon-Rot (DE); Stefan Thiem, Heidelberg (DE)

Correspondence Address: SIMPSON & SIMPSON, PLLC, 5555 MAIN STREET, WILLIAMSVILLE, NY, 14221-5406, US

(73) Assignee: Leica Microsystems Nussloch GmbH, Nussloch (DE)

(21) Appl. No.: 09/932,900

(22) Filed: Aug. 20, 2001

(30) Foreign Application Priority Data
Aug. 22, 2000 (DE) 100 41 230.0

(51) Int. Cl. G01N 35/00

(52) U.S. Cl. 422/65; 422/63; 422/99

(57) ABSTRACT

The present invention concerns an apparatus for treating objects, in particular cytological or histological specimens, having multiple processing stations (2) and a transport device (4) for delivering the objects into and out of the processing stations (2), a loading station (6) for loading with objects to be treated or object carriers (5) carrying the objects to be treated, and a removal station (7) for removing the treated objects or object carriers carrying the treated objects, being provided, which is characterized in that a definable number of processing stations can be allocated in fixed or variable fashion to the loading station (6) and/or the removal station (7).

### CROSS REFERENCE TO RELATED APPLICATIONS

This invention claims priority of the German patent application 100 41 230.0 files Aug. 22, 2000 which is incorporated by reference herein.

### FIELD OF THE INVENTION

The invention concerns an apparatus for treating objects, in particular cytological or histological specimens, having multiple processing stations and a transport device for delivering the objects into and out of the processing stations, a loading station for loading with objects to be treated or object carriers carrying the objects to be treated, and a removal station for removing the treated objects or object carriers carrying the treated objects, being provided.

### BACKGROUND OF THE INVENTION

The reader is referred, purely by way of example, to EP 0 849 582 A2. This document discloses a generic apparatus for treating objects, in particular cytological or histological specimens. In this, cytological or histological specimens are conveyed by way of an object carrier or basket to an automatic stainer, the automatic stainer comprising multiple processing stations.

The generic apparatus known from EP 0 849 582 A2 also already comprises a loading station for loading the apparatus with objects to be treated, as well as a removal station from which the objects already treated can be removed. The stations serving for loading and for removal are ultimately configured like a processing station, i.e. they each comprise a container for an object carrier. With the generic apparatus the objects to be treated must therefore be conveyed to the apparatus individually, and treated objects (together with their object carriers) must be removed individually. The operations of loading and removal ultimately define the working cycle time.

### SUMMARY OF THE INVENTION

It is the object of the present invention to configure and further develop an apparatus for treating objects, in particular cytological or histological specimens, in such a way as to make possible accelerated processing irrespective of loading and removal.

The aforesaid object is achieved by a generic apparatus for treating objects, in particular cytological and histological specimens, characterized by the improvement that a definable number of processing stations can be allocated in fixed or variable fashion to the loading station and/or the removal station.

What has been recognized according to the present invention is firstly that loading and removal are critical working steps which ultimately define the cycle time. It has also been recognized that it is advantageously possible to deviate from the proven system, in which objects carried by object carriers are submitted individually to the apparatus and also removed individually from the apparatus, if an adaptation is made such that a definable number of processing stations can be allocated to the loading station and/or the removal station. In other words, the apparatus according to the present invention differs from the existing art firstly in that the loading station and/or the removal station can be equipped with multiple processing stations, “processing station” ultimately being understood as a vessel such as the one arranged in the respective processing stations. In accordance with the requisite number of vessels, the loading station can be equipped with multiple processing stations so that the apparatus can be simultaneously loaded with multiple objects or object carriers carrying the objects. The removal station can be configured correspondingly, i.e. in accordance with the need. The manner in which the loading station on the one hand and removal station on the other hand are allocated or equipped can be variable, so that the loading station and, if applicable, the removal station can be modified as required. What is essential in any event is the fact that multiple object carriers can simultaneously be delivered into the loading station and the removal station.

Advantageously, up to four processing stations or vessels for receiving object carriers (racks) can be allocated to the loading station and/or the removal station. In this context it is of course possible to equip the loading station and, if applicable, the removal station only partially, or (if equipped fully) to load only one or the other vessel with object carriers. Any desired working procedure is conceivable.

In addition, very specific processing stations or vessels from the processing stations, namely selectable concrete processing stations, could be allocatable to the loading station and/or the removal station. In this respect the loading station and/or removal station, regarded per se, could be part of the area serving for processing, loading and removal taking place directly there. A feature of this kind could very considerably reduce the space requirements.

It is also advantageous if the processing stations can be allocated to the loading station and/or the removal station by means of the transport device. In this way, any desired vessels could be selected and delivered to the loading station and/or removal station or placed there. In the case of the removal station, processing stations or vessels that already contain the object carriers to be removed can be placed there. A further optimization would thereby be created.

It is furthermore possible for the processing station or corresponding vessels to be allocatable manually, preferably by mechanical connection, to the loading station and/or removal station. Ultimately both the loading station and the removal station would be equipped, before the beginning of actual processing, with the requisite number of vessels, so that processing can take place smoothly. In this context, the vessels can be connected mechanically to the loading station and/or removal station so that the latter are henceforth stationary. In the context of such a mechanical connection, it is possible for the processing stations or vessels to be bolted onto the loading station and/or removal station, or preferably clamped on by means of a bracket.

As already mentioned above, the processing stations can be embodied as containers for the specimen holders or racks. To this extent, the term “processing station” is to be understood not necessarily as the processing location, but rather as the vessel serving for processing.

In the context of a very particularly advantageous embodiment, the loading station and/or the removal station are equipped with sensors for detecting the presence of processing stations and optionally for identifying the number of processing stations. In this context it is possible at that time to identify automatically the manner in which the loading station and/or removal station is equipped.

It is furthermore possible to equip the loading station and/or removal station once again with sensors, specifically for detecting the presence of object holders or racks located in the processing stations, and optionally for identifying the number of object holders or racks in the processing stations. With this feature it is possible to determine the occupancy of the object holders or racks present in the loading station and/or in the removal station; here as well, an acoustic and/or optical indication is possible. Ultimately, an acoustic and/or optical signal could be provided when the removal station is entirely occupied and a removal is necessary. This feature, too, allows processing to be optimized, especially since complete filling of the removal station and thus the need for removal are indicated directly after occurrence of the corresponding event.

In additionally advantageous fashion, the loading station and/or removal station is embodied as a drawer, the drawer being manually or automatically openable and/or closable. In the context of a fully automatic embodiment, the drawer carrying the loading station could open automatically when the processing stations or vessels contained therein are entirely emptied. Similarly, the removal station could open automatically when the latter is entirely filled with object holders or racks to be removed.

In additionally advantageous fashion, the loading and/or removal of object holders or racks, preferably from any desired processing stations, could be accomplished by way of the transport device of the apparatus claimed. In this respect the transport apparatus serves on the one hand for removal from the loading station and transmittal to the respective processing stations, and on the other hand for removal from the last processing station and transfer into the removal station, which ultimately is equipped, like a processing station, with corresponding vessels.

For particularly simple and also variable handling of the object carriers, it is further advantageous if the transport device is embodied as a robot arm with end-located gripper. Multiple-element robot arms, in particular those comprising two partial arms, are advantageous; these are preferably arranged on a vertical shaft in height-adjustable fashion and rotatably thereon.

The transport device could additionally serve to transfer the object holder from an upstream station or upstream apparatus, and optionally to transmit it to a downstream station or downstream apparatus. For that purpose, for multiple-device operation, a cover provided in the housing could be opened so that the transport device can reach outside the actual apparatus. A lateral transfer, preferably through openings in the housing wall, is also possible, specifically through covers introduced laterally into the housing. The robot arm of the transport device could reach through openings configured in this fashion.

An automatic concatenation of multiple apparatuses and/or concatenation with multiple external stations is conceivable; once again, it is advantageous in this context if, for purposes of data interchange and in particular for purposes of synchronization, the stations or apparatuses are connected to and communicate with one another. Shared process control is possible.

### BRIEF DESCRIPTION OF THE DRAWINGS

There are various ways of advantageously embodying and developing the teaching of the present invention. The reader is referred, for that purpose, to the explanation below of an exemplary embodiment of the invention with reference to the drawings. In conjunction with the explanation of a preferred exemplary embodiment of invention with reference to the drawings, an explanation is also given of generally preferred embodiments and developments of the teaching. In the drawings,

FIG. 1 schematically depicts an exemplary embodiment of an apparatus according to the present invention in which the loading station and removal station are configured as drawers, the drawers being open.

### DETAILED DESCRIPTION OF THE INVENTION

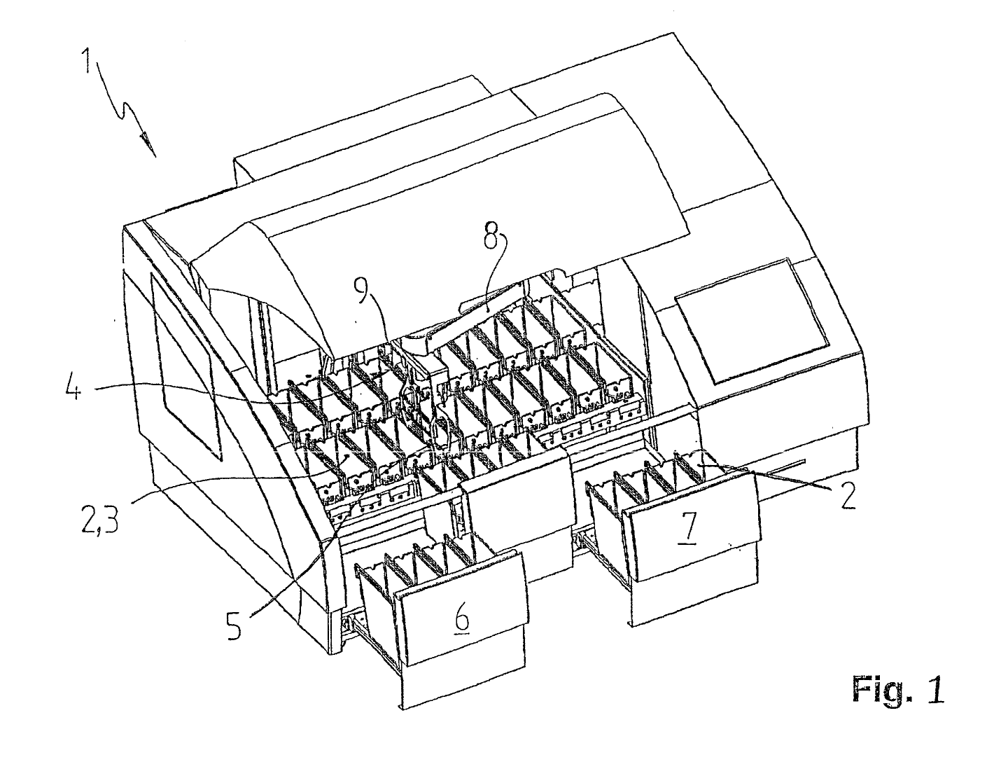

FIG. 1 shows an exemplary embodiment of an apparatus for treating objects, in particular cytological or histological specimens, this being concretely an automatic stainer 1. Automatic stainer 1 comprises multiple processing stations 2, these being embodied as vessels 3 for receiving the liquids used for treatment.

It is further evident from FIG. 1 that a transport device 4, which serves to deliver the objects into and out of processing stations 2, is provided.

Also provided are a loading station 6 for loading with objects to be treated or object carriers 5 carrying objects to be treated, and a removal station 7 for removal of the treated objects or object carriers 5 carrying the treated objects. In the embodiment shown, loading station 6 and removal station 7 are embodied as drawers.

According to the present invention, loading stations 6 and removal station 7 are equipped with a definable number of processing stations 2 or vessels 3; in the exemplary embodiment selected here, both loading station 6 and removal station 7 each have four processing stations 2 or vessels 3 allocated to them. As a consequence, in this case four object carriers 5 with corresponding objects can be submitted simultaneously, and four object carriers 5 with corresponding objects can be removed after they are treated.

Let it be noted at this juncture that loading station 6 and removal station 7 can have different processing stations 2 or vessels 3 allocated to them. This applies also with regard to the number of stations there.

It is furthermore advantageous if both loading station 6 and removal station 7 are “serviced” via transport device 4. By means of transport device 4, the object carriers present in loading station 6 can thus be removed and conveyed to the actual processing stations 2. After the last processing station 2, object carriers 5 are delivered into removal station 7 so that they can (together) be removed therefrom. Removal can be accomplished manually or once again automatically by way of a transport device.

In the exemplary embodiment selected here, transport device 4 used for handling object carriers 5 is embodied as robot arm 8, which has a total of two partial arms and a vertical guide. Robot arm 8 is rotatable about the vertical guide (not shown in the FIGURE) so that any desired location within the apparatus can be reached. A gripper 9 provided at the end of robot arm 8 serves to receive object carriers 5, thus making possible easy handling of object carriers 5.

In conclusion, be it noted very particularly that the exemplary embodiment discussed above serves merely for exemplary discussion of the teaching claimed, but does not limit it to the exemplary embodiment.

### PARTS LIST

1 Automatic stainer

2 Processing station, container

3 Vessel

4 Transport device

5 Object carrier

6 Loading station

7 Removal station

8 Robot arm

9 Gripper

What is claimed is:

1. In an apparatus for treating cytological or histological specimens, said apparatus having multiple processing stations and a transport device for delivering said specimens into and out of said processing stations, a loading station for loading with specimens to be treated or object carriers carrying said specimens to be treated, and a removal station for removing said treated specimens or said object carriers carrying said treated specimens, the improvement comprising:
a plurality of processing stations allocated to said loading station.

2. The improvement as defined in claim 1, wherein the number of processing stations in said plurality of processing stations is selected by a user and can be varied.

3. The improvement as defined in claim 2, wherein up to four processing stations can be allocated to said loading station.

4. The improvement as defined in claim 1, wherein said plurality of processing stations comprises selectable processing stations each having a specific function.

5. The improvement as defined in claim 1, wherein said plurality of processing stations are allocated to said loading station by means of said transport device.

6. The improvement as defined in claim 1, wherein said plurality of processing stations can be allocated manually to said loading station.

7. The improvement as defined in claim 6, wherein said plurality of processing stations are bolted onto said loading station.

8. The improvement as defined in claim 6, wherein said plurality of processing stations are clamped onto said loading station by means of a bracket.

9. The improvement as defined in claim 1, wherein said plurality of processing stations are embodied as containers for said object carriers.

10. The improvement as defined in claim 1, wherein said loading station is equipped with sensors for detecting the presence of processing stations therein.

11. The improvement as defined in claim 10, wherein said sensors identify the number of processing stations in said plurality of processing stations.

12. The improvement as defined in claim 1, wherein said loading station is equipped with sensors for detecting the presence of said object carriers located in said plurality of processing stations.

13. The improvement as defined in claim 12, wherein said sensors identify the number of object carriers in said plurality of processing stations.

14. The improvement as defined in claim 12, wherein the occupancy of said object carriers present in said loading station is indicated acoustically.

15. The improvement as defined in claim 12, wherein the occupancy of said object carriers present in said loading station is indicated optically.

16. The improvement as defined in claim 1, wherein said loading station is embodied as a drawer.

17. The improvement as defined in claim 16, wherein said drawer is automatically openable and closable.

18. The improvement as defined in claim 1, wherein said object carriers are loaded from said plurality of processing stations in said loading station to desired ones of said multiple processing stations of said apparatus by said transport device.

19. The improvement as defined in claim 1, wherein said transport device is embodied as a robot arm having a gripper located at an end thereof.

20. In an apparatus for treating cytological or histological specimens, said apparatus having multiple processing stations and a transport device for delivering said specimens into and out of said processing stations, a loading station for loading with specimens to be treated or object carriers carrying said specimens to be treated, and a removal station for removing said treated specimens or said object carriers carrying said treated specimens, the improvement comprising:
a plurality of processing stations allocated to said removal station.

21. The improvement as defined in claim 20, wherein the number of processing stations in said plurality of processing stations is selected by a user and can be varied.

22. The improvement as defined in claim 21, wherein up to four processing stations can be allocated to said removal station.

23. The improvement as defined in claim 20, wherein said plurality of processing stations comprises selectable processing stations each having a specific function.

24. The improvement as defined in claim 20, wherein said plurality of processing stations are allocated to said removal station by means of said transport device.

25. The improvement as defined in claim 20, wherein said plurality of processing stations can be allocated manually to said removal station.

26. The improvement as defined in claim 25, wherein said plurality of processing stations are bolted onto said removal station.

27. The improvement as defined in claim 25, wherein said plurality of processing stations are clamped onto said removal station by means of a bracket.

28. The improvement as defined in claim 20, wherein said plurality of processing stations are embodied as containers for said object carriers.

29. The improvement as defined in claim 20, wherein said removal station is equipped with sensors for detecting the presence of processing stations therein.

30. The improvement as defined in claim 29, wherein said sensors identify the number of processing stations in said plurality of processing stations.

31. The improvement as defined in claim 20, wherein said removal station is equipped with sensors for detecting the presence of said object carriers located in said plurality of processing stations.

32. The improvement as defined in claim 31, wherein said sensors identify the number of object carriers in said plurality of processing stations.

33. The improvement as defined in claim 31, wherein the occupancy of said object carriers present in said removal station is indicated acoustically.

34. The improvement as defined in claim 31, wherein the occupancy of said object carriers present in said removal station is indicated optically.

35. The apparatus as defined in claim 33, wherein complete filling of said removal station, and thus the need for removal, is indicated acoustically.

36. The apparatus as defined in claim 34, wherein complete filling of said removal station, and thus the need for removal, is indicated optically.

37. The improvement as defined in claim 20, wherein said removal station is embodied as a drawer.

38. The improvement as defined in claim 37, wherein said drawer is automatically openable and closable.

39. The improvement as defined in claim 20, wherein said object carriers are loaded from desired ones of said multiple processing stations of said apparatus to said plurality of processing stations in said removal station by said transport device.

40. The improvement as defined in claim 20, wherein said transport device is embodied as a robot arm having a gripper located at an end thereof.

41. In a system having a plurality of sequentially arranged apparatuses for treating cytological or histological specimens, each said apparatus having multiple processing stations and a transport device for delivering said specimens into and out of said processing stations, a loading station for loading with specimens to be treated or object carriers carrying said specimens to be treated, and a removal station for removing said treated specimens or said object carriers carrying said treated specimens, the improvement comprising:
said transfer device serving to transfer said object carriers from an upstream apparatus to the apparatus with which said transport device is associated.

42. The improvement as defined in claim 41, wherein said transfer device further serves to transfer said object carriers from the apparatus with which said transport device is associated to a downstream apparatus.

43. The improvement as defined in claim 41, wherein said apparatuses in said system are connected to communicate data with one another, whereby treatment of said specimens can be synchronized.
